(19) United States
(12) Patent Application Publication
(10) Pub. No.: US 2013/0340488 A1
(43) Pub. Date: Dec. 26, 2013

(54) GRAVITY DRAIN WASHING MACHINE WITH IMPROVED DRAIN CONTROL VALVE

(71) Applicants: Brian Wohlgemuth, Kellogg, IA (US); Daryl T. Johnson, Ripon, WI (US)

(72) Inventors: Brian Wohlgemuth, Kellogg, IA (US); Daryl T. Johnson, Ripon, WI (US)

(73) Assignee: Alliance Laundry Systems LLC., Ripon, WI (US)

(21) Appl. No.: 13/533,615

(22) Filed: Jun. 26, 2012

(51) Int. Cl. D06F 37/00; F16K 31/02

(52) U.S. Cl. 68/208; 251/129.11

(57) ABSTRACT

A gravity drain laundry machine having a flapper style drain valve for controlling the discharge of wash water from the machine following a washing cycle. An electric motor is operable for moving the flapper plate from between open and closed positions, and a linkage interconnects an output shaft of the motor and the flapper plate which retains the flapper plate in a closed position with lesser torque requirements of the motor. The motor also is mountable on either side of the drain valve for the particular laundry machine configuration.

### FIELD OF THE INVENTION

The present invention relates generally to laundry washing machines, and more particularly, to gravity drain laundry washing machines in which wash water drains from a wash tub by gravity under control of a drain valve.

### BACKGROUND OF THE INVENTION

Many large commercial laundry washer extractors utilize a gravity drain for draining water from the laundry wash tub following wash and rinse cycles. In such washing machines there is no electric pump for forcing the water from the laundry machine, but instead, water flows by gravity to a drain, normally in the floor of the laundry facility.

In such gravity drain washing machines, a drain valve is provided that is closed to retain water within the wash tub during the washing cycle, and an electric motor is provided to control opening and closing of the valve. Heretofore, such drain valves have had poor reliability due to excessive variability in the forces required to open and close the valve. Drain valves with a rotatable ball design are particularly problem prone due to the sliding nature of the ball that results in the valve sticking and not fully closing due to wear or contaminants and corrosive chemicals in the wash water. Flapper style drain valves which utilize a flapper plate that is pivoted between open and closed positions have been utilized in an effort to eliminate relative sliding movement of the valve components and the resulting variability in the opening and closing forces of ball valves. Such flapper style dump valves, however, require relatively high torque motors for maintaining the required sealing force on the flapper plate and can be subject to leakage due to poor sealing contact.

### OBJECTS AND SUMMARY OF THE INVENTION

It is object of the present invention to provide a gravity drain laundry washing machine with a drain valve adapted for more reliably controlling the retention and discharge of wash water used during washing cycles.

Another object is to provide a gravity drain laundry machine as characterized above which has a flapper style drain valve adapted for reliable operation with a lower torque motor.

A further object is to provide a gravity drain washing machine with a flapper style drain valve of the above kind effective for more reliably maintaining the flapper valve in a closed condition, while minimizing the required torque of the electric control motor.

Still another object is to provide a gravity drain washing machine with a flapper style drain valve of the foregoing type adapted for more effectively sealing the flapper plate in a closed position.

Yet another object is to provide a laundry machine with such a drain valve which is relatively simple in design and lends itself to economical manufacture.

Other objects and advantages of the invention will become apparent upon reading the following detailed description and upon reference to the drawings, in which:

### BRIEF DESCRIPTION OF THE DRAWINGS

FIG. 1 is a perspective of an illustrative laundry washing machine having a drain valve in accordance with the invention;

FIG. 2 is an enlarged perspective of the drain valve in relation to outlet and drain piping of the illustrated machine;

FIG. 3 is a perspective of the illustrated drain valve and associated drain valve control motor;

FIG. 4 is an enlarged vertical section of the illustrated drain valve and motor taken in the plane of lines 4-4 in FIG. 3;

FIG. 5 is a side elevational view of the illustrated drain valve with the flapper plate thereof in an open position;

FIG. 6 is a longitudinal section of the drain valve shown in FIG. 5;

FIG. 7 is a side elevational view of the drain valve with the flapper plate in a closed position;

FIG. 8 is a longitudinal section of the drain valve as shown in FIG. 7;

FIG. 9 is a perspective of the illustrated drain valve with the flapper plate in an open position;

FIG. 10 is a perspective of the illustrated drain valve with the flapper plate in a closed position;

FIG. 11 is a perspective of the drain valve with a motor mounting plate affixed thereto; and

FIG. 12 is an exploded perspective of the illustrated drain valve.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

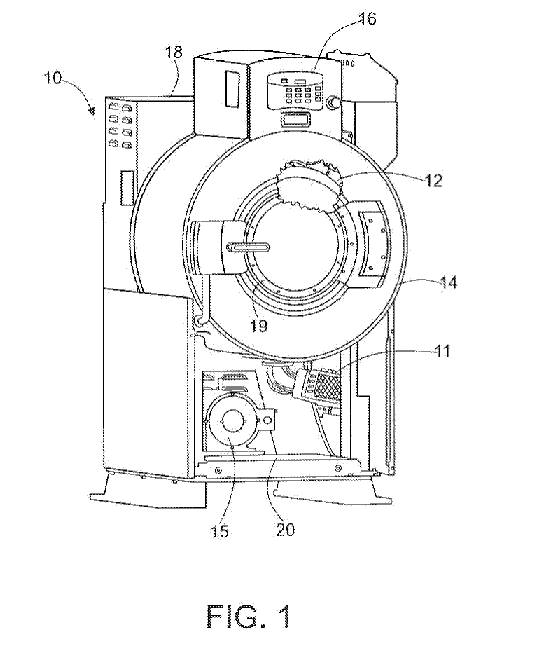

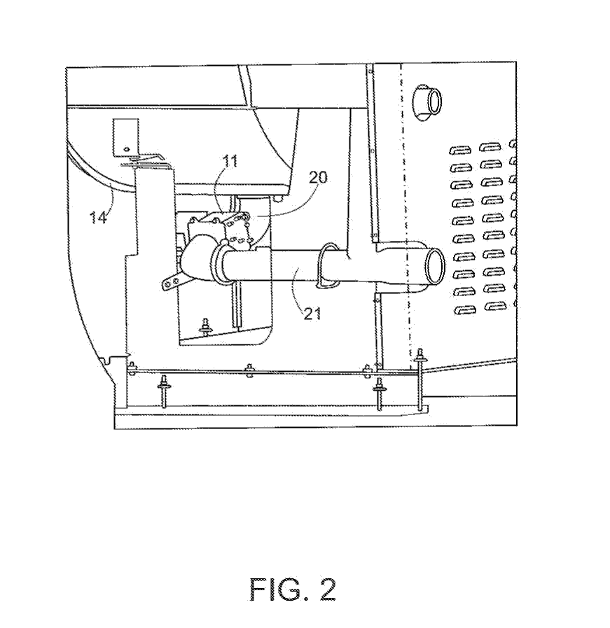

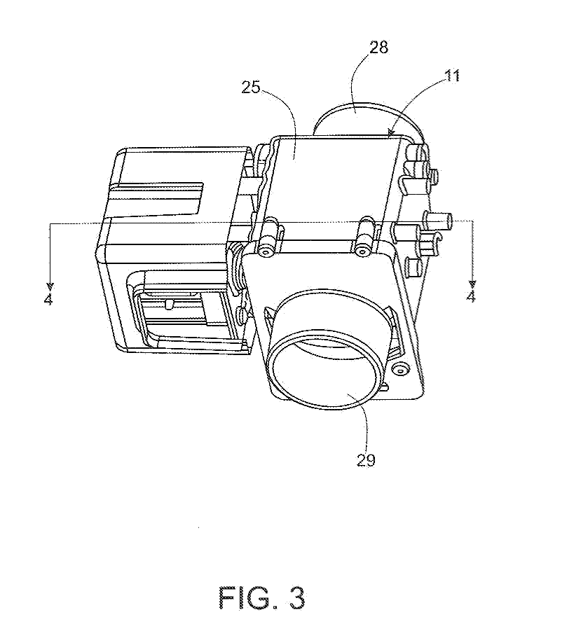

Referring now more particularly to FIG. 1 of the drawings, there is shown an illustrative gravity drain washing machine 10 having a drain valve 11 in accordance with the invention. The illustrated washing machine 10 has a front opening cylindrical basket 12 for receiving clothes and other items to be laundered, which is disposed for rotation about a horizontal axis within a cylindrical wash tub 14 into which water is directed during various washing cycles. An electric motor 15 is provided for driving the cylindrical basket 12 in a known manner, and an operator control panel 16 in this case is disposed adjacent a cabinet 18 of the machine 10. The cabinet 18, a portion of which is removed in FIG. 1 for clarity of illustration, has a front opening door 19 for providing access to the rotary basket 12. Since the basic design and operation of the washing machine 10 is conventional, it need not be described in detail. Suffice it to say, water directed into the wash tub 14 from inlet piping for use during a washing cycle can be selectively drained by gravity through outlet piping 20 communicating with the tub 14, with the drain valve 11 controlling the discharge of water to drain piping 21.

In accordance to the invention, the drain valve has a flapper design effective for more reliable trouble-free operation. In the illustrated embodiment, the drain valve 11 has a housing 25 which comprises a central body portion 26 with an inlet port 28 coupled to the wash tub outlet piping 20 and an outlet port 29 coupled to the drain piping 21. The drain valve 11 defines a liquid flow passage 27 between the inlet and outlet ports 28, 29 and includes a flapper plate 30 mounted for pivotable movement about an upper end between a closing position for blocking the flow of liquid from the washer tub 14 through the drain valve 11 and a raised open position for permitting the discharge of water by gravity from the washing machine to the drain piping 21. The illustrated flapper plate 30 is disposed adjacent a downstream end of the inlet port 28 of the valve housing 25 for closing the inlet port 28 when in the closed position. The flapper plate 30 in this case has a molded plastic construction with integral support shaft segments 31a, 31b extending outwardly from opposite top sides of the flapper plate 30. It will be understood that while the illustrated flapper plate 30 has integrally-formed shaft segments 31a, 31b, alternatively, the flapper plate could be fixedly mounted on a separate and discrete pivot shaft.

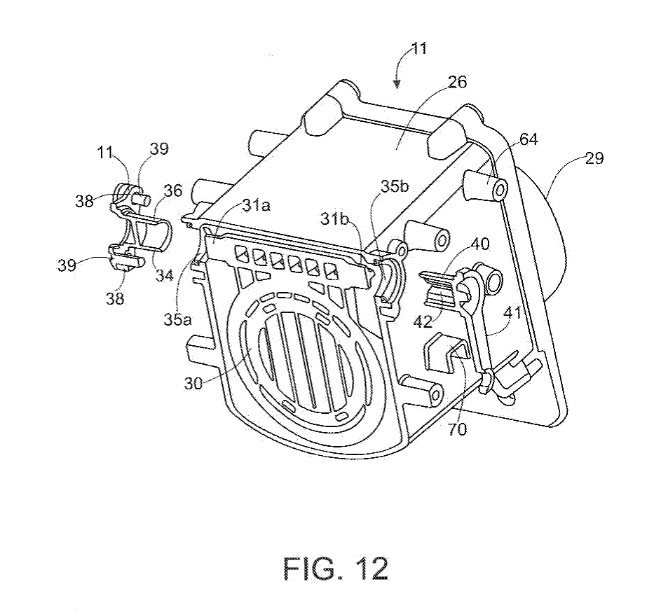

For rotatably supporting the flapper plate 30 for pivotal movement relative to the housing 25, in this case one of the opposed shaft segments 31a is rotatably supported within a bushing 34 mounted in a cylindrical opening 35a on one side of the housing 25 (FIG. 12). The bushing 34 has a cylindrical hub 36 for rotatably receiving the shaft segment 31a and a pair of outwardly extending support flanges 38 secured to the housing 25 by threaded fasteners 39. The other shaft segment 31b is disposed within a cylindrical hub 40 of a flapper plate crank arm 41, rotatably supported within a cylindrical opening 35b on an opposite side of the housing 25. The shaft segment 31b has a radial drive key or lug 42b that is disposed within a similar key receiving slot 42 of the crank arm bushing 40 to form a keyed coupling such that rotation of the crank arm 41 will rotate the shaft segment 31b and flapper plate 30.

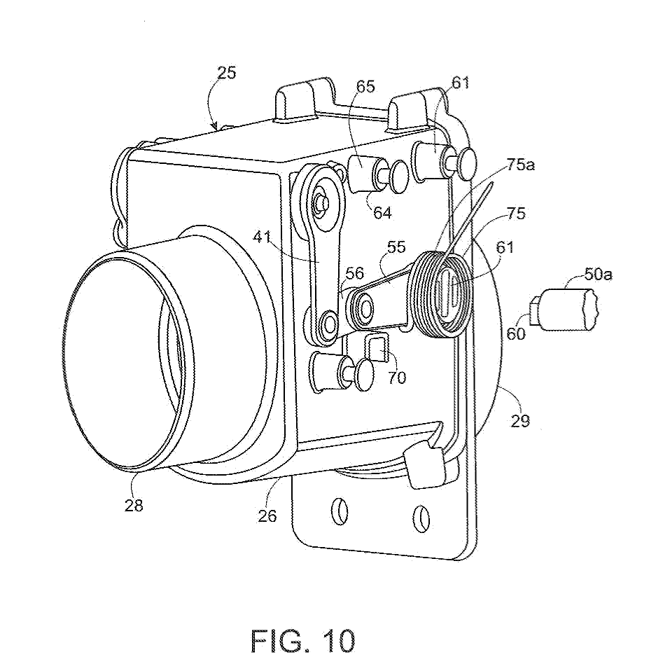

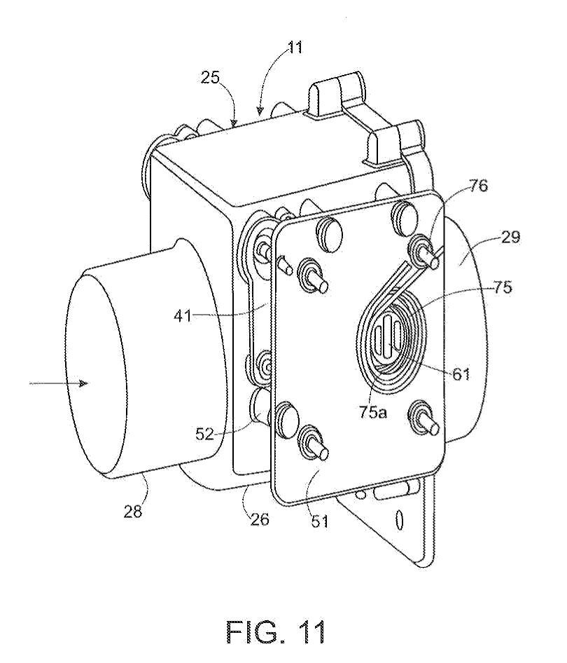

For pivoting the flapper plate from the open position to the closed position, a drain valve motor 50 is mounted on a side of the valve housing 25, which may be a conventional electric gear motor with an output shaft 50a (FIG. 10) driven at a predetermined reduced speed. The drain valve motor 50 in this case has an outer cover 53 and is fixed to a mounting plate 51 (FIG. 11), such as by threaded fasteners, and the mounting plate in turn is mounted on standoffs 52 extending outwardly from the drain valve housing 25 for supporting the drain valve motor 50 in spaced relation to the side of the housing 25 with the output shaft 50a of the gear motor 50 disposed within the spacing.

In keeping with the invention, the drain valve motor 50 is operable through linkage which pivots the flapper plate 30 between open and closed positions as an incident to operation of the motor 50 and which more effectively retains the flapper plate 30 in closed sealed relation to the inlet port 28. To this end, in the illustrated embodiment, the drain valve motor output shaft 50a has a crank arm 55 having an outer end pivotably coupled to an outer end of the flapper plate crank arm 41 through an intermediate pivot link 56. The motor output shaft 50a, has a keyed connection with a hub 58 of the motor crank arm 55, in this case, including a radial key 60 positioned within a complementary radially oriented key receiving slot 61 in the hub 58. (FIG. 10)

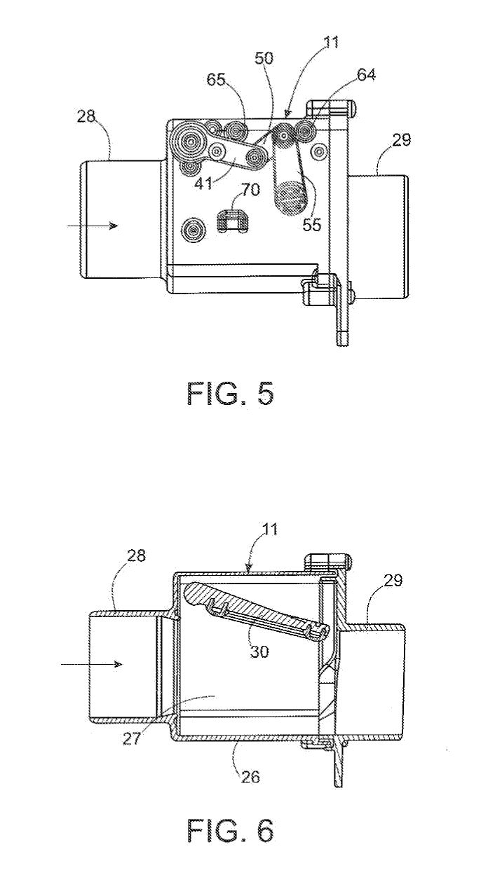

When the flapper plate 30 is in the open position, as shown in FIGS. 5, 6 and 9, motor crank arm 55 is in a raised position at a small angle to the vertical, such as about 5°, as established by a stop 64 affixed to the housing 25, the flapper crank arm 41 is raised to a position short of horizontal by a small angle, such as about 5°, established by a stop 65 fixed to the housing, and the intermediate pivot link 56 between the motor and flapper crank arms 55, 41 is at an angle of about 45° to the vertical. It will be understood that the standoffs between the drain valve 11 and the motor mounting plate 51 may appropriately positioned to further function as the stop 64, 65.

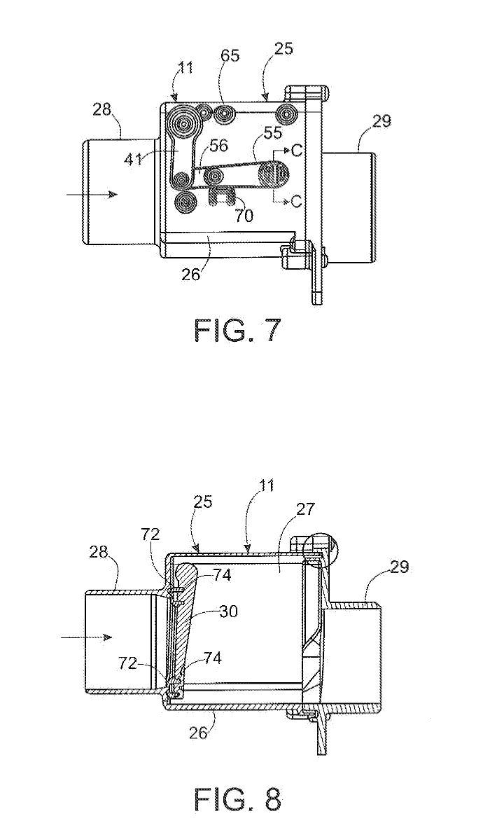

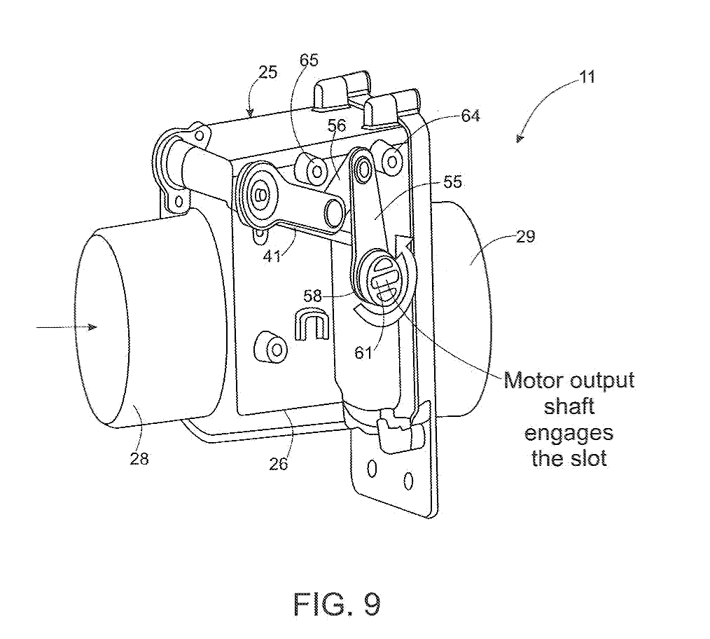

As can be seen with reference to FIGS. 7, 8 and 10, operation of the drain valve motor 50 will rotate the motor crank arm 55 counter clockwise, as viewed in FIG. 9, to a position just short of the horizontal, as limited by a stop 70, in turn pivoting the flapper plate crank arm 41, clockwise to a substantially vertical position, and thereby pivoting the flapper plate 30 downwardly to a substantially vertical position closing the inlet port 28 of the drain valve 11. In such closed position, it can be seen that the motor crank arm 55 and intermediate link 56 are in substantially aligned perpendicular relation to the flapper plate crank arm 41, and hence, the flapper plate 30, causing the flapper plate 30 to close the inlet port 28. As will be understood by a person skilled in the art, the effective lengths of the crank arm 55 and intermediate pivot link 56 can be appropriately designed for urging the flapper plate into the closed position with the desired closing pressure. The linkage 55, 56, furthermore, effectively holds the flapper plate 30 in closed position without additional torque requirements of the motor 50. In the illustrated embodiment, it can be seen that the motor crank arm 55 and intermediate link 56 are in substantial alignment, as located by the stop 70, just short of an over centered position, for facilitating return output movement of the motor crank arm 55 and intermediate link 56 upon opening of the flapper plate 30, as will become apparent.

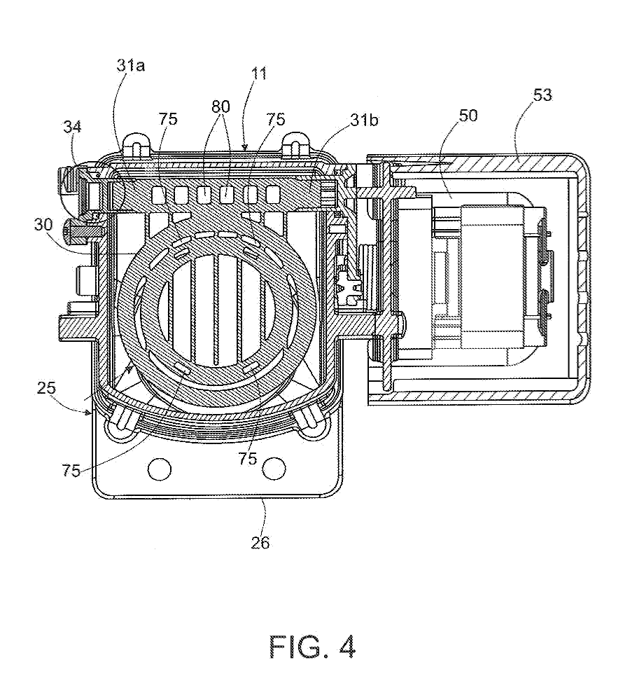

For enhancing sealing contact between the flapper plate 30 and the inlet port 28 when the flapper plate 30 is in a closed position, the flapper plate 30 has a plastic sealing member 72 about the side facing the inlet port 28. The sealing member 72 in this case is in the form of a flat molded plastic annular member having rearwardly extending barbs 74 about its periphery for removable engagement within arcuate slots 75 formed in the molded plastic flapper plate 30 (FIGS. 4 and 8). It will be appreciated that such sealing member 72 can be periodically replaced in a convenient and economical manner for ensuring that the flapper plate 30 maintains an effective and secure seal with the inlet port 28 when in a closed position. And as indicated above, reliable optimum sealing pressure can be controlled by design of the crank arm 55, 41, and intermediate link 56.

For pivoting the flapper plate 30 from the vertical closed position to an upwardly pivoted open position for enabling water within the washing machine to drain through the drain valve 11 to the drain piping 21, a torsion spring 75 in this case is provided for biasing the flapper plate 30 to the raised position. In this case, a torsion spring 75 has a cylindrical coil section 75a disposed about the gear motor crank arm hub 58, with one end fixed about the motor crank arm 55 and the other end biased against a stop pin 76 fixed to the mounting plate 51 (FIGS. 10 and 11). The torsion spring 75 is retained in a biased condition between the motor crank arm 55 and stop pin 76 for biasing the flapper plate 30 in an opening direction. As will be understood, the drain valve gear motor 50 has a power sufficient to overcome the biasing force of the spring 75 for moving the flapper plate 30 to the closed position, as indicated above, and upon de-energization of the motor 50, the torsion spring 75 automatically will return the flapper plate 30 to the raised drain opening position.

In carrying out a further feature of the illustrated embodiment, the drain valve 11 is designed for enabling the drain valve motor 50 to be mounted on either side of the drain valve housing 25 in order to facilitate mounting in washing machines of different configurations. To this end, in the illustrated embodiment, the shaft segments 31a, 31b of the flapper plate 30 are identical in form, each having a radial drive key 42 for enabling a keyed connection with the socket or hub 40 of the flapper plate crank arm 41, depending upon the side of the drain valve 11 upon which the motor 50 is mounted. The bushing 34 has a cylindrical internal diameter for rotatably supporting either shaft segment 31a, 31b, of the flapper plate 30, depending upon the mounting position of the drive motor 50.

It will be appreciated by one skilled in the art that the drain valve 11 in accordance with the invention is relatively simple in design and adapted for economical manufacture. Effective sealing and retention of the flapper plate 30 in the closed position is effected without substantially increasing the torque requirement of the drain valve motor 50. In practice, reliable operation can be achieved by utilizing a conventional shaded pole a/c gear motor having output shaft speed of between 18 and 30 rpm, a minimum starting torque of 3.5 inch pounds, and a running torque of between 14 and 20 inch pounds. The flapper plate 30, motor and flapper crank arms 55, 41 and the intermediate link 50 also all may be economically formed by plastic injection molding. A plastic material, such as commercially available plastic sold under the tradename “A Model A-1145HS”, may be used, which is chemical resistant, rigid, and heat resistant sufficient to withstand loads when exposed to water temperatures up to 195° F. The flapper plate 30 in this case also is formed with a plurality of laterally spaced recesses 80 between the shaft segments 31a, 31b to reduce material and a plurality of elongated central recesses 81 which both reduce material and define reinforcing rigs of the flapper plate 30. Hence, it can be seen from the foregoing that a washing machine with a flapper style gravity drain valve is provided that is adapted for reliable operation with a lower torque motor and which has a simple and versatile design which lends itself to economical manufacture.

What is claimed is:

1. A gravity drain laundry washing machine comprising:
a wash tub for receiving water during a washing operation,
said wash tub having a water outlet,
a drain valve having an inlet port coupled to said wash tub outlet and an outlet port coupled to a drain,
said drain valve having a flapper plate pivotably supported for movement between a closed position preventing the flow of water from said wash tub through said drain valve outlet port and an open position for permitting the gravity flow and draining of water from said wash tub through said wash tub outlet and drain valve to the drain,
an electric motor having an output shaft operable for moving said flapper plate from said open position to said closed position,
a linkage interconnecting said drive motor and said flapper plate including a motor crank arm fixed to said motor output shaft, a flapper plate crank arm fixed to said flapper plate, and at least one intermediate link coupled between said motor crank arm and flapper plate crank arm such that operation of said motor causes said interconnecting linkage to move said flapper plate from said open position to said closed position.

2. The gravity drain laundry washing machine of claim I in which said linkage includes a single intermediate link interconnecting said motor crank arm and said flapper plate crank arm.

3. The gravity drain laundry washing machine of claim 2 in which upon energization of said motor the output shaft rotates said motor crank arm and intermediate link into substantial aligned relation to each other transverse to the flapper plate for maintaining the flapper plate in the closed position.

4. The gravity drain laundry washing machine of claim 1 in which as an incident to movement of the flapper plate to the open position, the motor crank arm is moved to a position oriented at an angle of about 5° to the flapper plate.

5. The gravity drain laundry washing machine of claim 1 including a torsional spring for biasing said flapper plate to the open position, said motor being operable upon energization for overcoming the biasing force of the torsional spring when moving the flapper plate to the closed position, and said torsional spring being operable for biasing the flapper plate to the open position upon de-energization of said motor.

6. The gravity drain laundry washing machine of claim 1 in which said motor crank arm and intermediate link are positioned in substantially perpendicular relation to said flapper plate when said flapper plate is in the closed position.

7. The gravity drain laundry washing machine of claim 1 in which said motor crank arm and intermediate link are positioned substantially perpendicular to said flapper plate crank arm when said flapper plate is in the closed position.

8. The gravity drain laundry washing machine of claim 1 in which said drain valve includes a housing, and said motor is selectively mountable on either side of said drain housing for operative coupling to said linkage.

9. The gravity drain laundry washing machine of claim 8 in which said flapper plate includes a support shaft, one end of said support shaft being rotatably supported within a bushing mounted to said housing, and the other end of said support shaft being coupled to said flapper plate crank arm.

10. The gravity drain laundry washing machine of claim 9 in which said bushing is mountable on either side of said housing for supporting either end of said support shaft.

11. The gravity drain laundry washing machine of claim 1 in which said flapper plate has a sealing member mounted on a side of the flapper plate for sealing engagement with one of said inlet and outlet ports upon movement of the flapper plate to the closed position.

12. The gravity drain laundry washing machine of claim 11 in which said sealing member has rearwardly extending mounting barbs for releasable securement within apertures in the flapper plate.

13. A gravity drain laundry washing machine comprising:
a wash tub for receiving water during a washing operation,
said wash tub having a water outlet,
a drain valve having a housing defining a liquid flow passage with an inlet port coupled to said wash tub outlet an outlet port coupled to a drain,
said drain valve having a flapper plate with a pivot shaft pivotably supporting the flapper plate for movement between a closed position preventing the flow of water from said wash tub through said drain valve flow passage and an open position for permitting the gravity flow and draining of water from said wash tub through said wash tub outlet and drain valve liquid flow passage to the drain,
an electric motor having an output shaft operable for moving said flapper plate from said open position to said closed position, a linkage interconnecting said motor output shaft and said flapper plate including a motor crank arm fixed to said motor output shaft, a flapper plate crank arm fixed to said flapper plate, and single intermediate link coupled between said motor crank arm and flapper plate crank arm such that operation of said motor causes said interconnecting linkage to move said flapper plate from said open position to said closed position.

14. The gravity drain laundry washing machine of claim 13 in which upon energization of said motor the output shaft rotates said motor crank arm and intermediate link into substantial aligned relation to each other transverse to the flapper plate for maintaining the flapper plate in the closed position.

15. The gravity drain laundry washing machine of claim 13 in which said motor is selectively mountable on either side of said drain housing for operative coupling to said linkage.

16. The gravity drain laundry machine of claim 15 in which said support shaft includes identical shaft segments at opposite ends.

17. The gravity drain laundry machine of claim 16 including a bushing mountable on either side of said housing for supporting the shaft segment on either end of said support shaft, and said flapper plate crank arm being operably keyable to the shaft segment on either end of said support shaft.

18. A gravity drain valve for controlling the discharge of liquid from a liquid outlet to a drain comprising:
a valve housing having an inlet port coupled to said liquid outlet and an outlet port coupled to said drain,
a flapper plate pivotably supported by said housing for movement between a closed position preventing the flow of liquid from inlet port to said drain and an open position for permitting the gravity flow and draining of liquid from said liquid outlet to said drain,
an electric motor having an output shaft operable for moving said flapper plate from said open position to said closed position,
a linkage interconnecting said drive motor and said flapper plate including a motor crank arm fixed to said motor output shaft, a flapper plate crank arm fixed to said flapper plate, and at least one intermediate link coupled between said motor crank arm and flapper plate crank arm such that operation of said motor causes said interconnecting linkage to move said flapper plate from said open position to said closed position.

19. The gravity drain laundry washing machine of claim 18 in which said linkage includes a single intermediate link interconnecting said motor crank arm and said flapper plate crank arm.

20. The gravity drain laundry washing machine of claim 18 in which said motor crank arm and intermediate link are positioned in substantially perpendicular relation to said flapper plate when said flapper plate is in the closed position.
